(19) United States
(12) Patent Application Publication
(10) Pub. No.: US 2026/0107099 A1
(43) Pub. Date: Apr. 16, 2026

(54) In-ear device with a cerumen protection unit

(71) Applicant: SONOVA AG, Staefa (CH)

(72) Inventors: Fabio Schmidt, Uetikon am See (CH); Manuel Weibel, Goldach (CH); Nathalie Leuthold, Staefa (CH); Arno Römmeler, Zürich (CH)

(21) Appl. No.: 19/354,331

(22) Filed: Oct. 9, 2025

(30) Foreign Application Priority Data
Oct. 10, 2024 (EP) 24205862.6

(51) Int. Cl. H04R 25/00

(52) U.S. Cl. CPC H04R 25/652

(57) ABSTRACT

Described herein is an in-ear device that is at least partially insertable into an ear canal of a user. The in-ear device comprises a housing that is mechanically releasably coupled to a connector by way of a dedicated opening provided in the housing. The connector is made of an elastic material, a tubular overall shape defining a longitudinal axis and radially delimits a sound channel. The connector is mechanically releasably coupled to a loudspeaker unit at a second end of the connector. A cerumen protection unit is connected to the connector by an adhesive-free and non-losable connection.

### RELATED APPLICATIONS

The present application claims priority to EP Patent Application No. 24205862.6, filed October 10, 2024, which is hereby incorporated by reference in its entirety.

### BACKGROUND INFORMATION

Hearing devices in the present context include devices used for providing an output signal based on an electric audio signal to a user to evoke a hearing perception. The audio signal is representative of audio content and may be based on ambient sound captured by the hearing device itself or may be provided to the hearing device by an external audio source e.g., via an audio stream from an external microphone or a streaming service. The audio signal may be processed in the hearing device to obtain the output signal. The audio processing may include simple amplification but may also use other augmentation as e.g., situational enhancement of an acoustic scene as e.g., beamforming and/or active noise cancelling (ANC). Such hearing devices may be used to improve the hearing capability of a user and/or may be used for consuming audio content.

Hearing devices that are specifically configured to compensate for a hearing loss of hearing-impaired users are commonly referred to as hearing instruments, hearing aids, or hearing prostheses. Hearing instruments are typically configured to produce an output signal that can be perceived by a user despite her or his hearing impairment. The output signal is typically based on ambient sound which may be captured in the vicinity of the user by an internal or external microphone. The output signal may comprise amplified and/or otherwise processed sound that can be delivered via a loudspeaker unit (also called “receiver” in the context of hearing instruments and hereinafter) to the ear canal of a user.

In the present context, the term “hearing device” denotes so-called in-ear devices. Exemplary embodiments of such in-ear devices are in-the-ear (ITE) hearing devices or earbuds. Earbuds are typically configured for listening to music, podcasts, and other audio information. Earbuds can have an ANC functionality and only a limited hearing loss compensation, if they provide any hearing loss compensation functionality at all. Different thereto, ITE devices are heavily focusing on the compensation of the hearing loss of a user.

The present embodiments cover both monoaural and binaural hearing systems. Thus, when addressing items in singular below, they also cover binaural hearing systems.

The hearing devices may be inserted into the ear canal of a user at least in part to deliver the output sound signal to the ear canal. That is why one refers to them as “in-ear devices”. An in-ear device part that is inserted into the ear canal may be retained in its designated place with sufficient reliability and comfort for the user while simultaneously fulfilling a sealing function for achieving the desired type of acoustic coupling of the hearing device to the ear canal (e.g., occluded or open fitting). That is why there is a tendency to shape an outer surface of these in-ear devices that is touching the interior of the ear canal according as good as it gets to the geometry of the ear canal of the user and is forming a housing of the hearing device accordingly. In case of earbuds, the housing can have a customized shape of the user’s ear canal, a good approximation thereto or a standard housing. In most cases, the material of the housing of a conventional earbud is a comparatively rigid plastic with a soft dome that seals off the ear canal and holds the earbud in the ear canal. In case of an ITE, the housing is typically formed by a so-called custom shell that is made according to an ear canal imprint of the user’s ear canal to ensure a snug fit and highest comfort. These shells or ITE-housings can be made of a plastic, for example an acryl, and formed by additive manufacturing or casting. Alternatively, shells/housings can be made of additive manufactured titanium to meet highest wearing comfort and any hypoallergenic features. Moreover, such custom shells are unbreakable.

Independent of the housing material, the housing has a fully individual shape that can differ drastically from one user to another user. To allow for some standardization, it became common to provide a standardized dedicated opening at the medial end of the housing, i.e., at the end of the housing that is facing the eardrum when in use. The terms “medial” and “lateral” used hereinafter denote their position towards the center of the head of a user and away from the head of the user, respectively, once the in-ear device is inserted in the ear canal of the user.

That dedicated opening forms a standardized tubular mechanical connector that allows for positioning and fastening a deformable plastic tube having a first coupling geometry configured to receive a coupling portion, for example a spout, of the loudspeaker unit relative to the housing.

During use, hearing devices come in close contact with the user's ear and are exposed to undesired factors/pollutants such as earwax, sebum, tissue particles or other debris. Tissue particles may include skin flakes or scales, as e.g., dandruff and the like. Sebum is a slightly acidic oily substance produced by the sebaceous glands in the skin which helps moisturize and protect the skin. Earwax, also known as cerumen, is a natural lubricant present in the ear canal. Such pollutants, solid or liquid, are notoriously known to enter through any opening of hearing devices, particularly the sound channel of the loudspeaker unit. The pollutants may advance from there to electrical parts of the hearing device and/or may clog the opening of the sound canal. When inserting the in-ear device into the user's ear canal these undesired factors/pollutants may enter a sound channel which connects a functional component of the hearing device as e.g., a receiver with a sound outlet opening.

To prevent or at least hamper the ingress of these pollutants into functional components of the hearing device, it is known to incorporate suitable mechanical filtering elements in hearing devices. Such filtering elements are often referred to as cerumen filters or wax filters. Cerumen filters are typically arranged in or downstream of outer openings that may allow ingress of pollutants. The cerumen filters may also quickly deteriorate due to accumulation of cerumen or other pollutants which leads to a reduced volume of transmitted sound or a muffled tone.

To provide a protection of the sound channel of the delicate loudspeaker unit that is pointing towards the ear drum when in use against any undesired ingress of cerumen, a cerumen protection unit is provided at the medial end of the in-ear device. In one embodiment, the cerumen protection unit comprises a filter bushing that is glued in the medial end of the tubular connector that is pointing towards the ear drum in an operating state of the in-ear device. The filter bushing is designed as a coupling means to receive and hold a replaceable filter element.

There are disadvantages with such a cerumen protection unit. First, the filter bushing is glued into a free end of the tubular connector during the assembly process by way of an adhesive. Owing to the small dimensions of the cerumen protection unit and the diameter of the sound channel in the connector, this is precision work involving miniature components such that the assembly process gets expensive. Moreover, administrating a gluing process tends to be a rather messy and cumbersome business owing to the stickiness of the adhesive. Additionally, the end user likely may visit a hearing care practitioner (HCP) to have that done.

Second, there is a risk that the filter bushing and its filter element become loose while the user wears the in-ear device if there is a flaw in the gluing process. As a result, the tiny cerumen protection unit can fall out of its designated gluing position and move freely in the ear channel until a doctor removes it. Owing to the small overall dimensions of the cerumen protection unit, the user may not even notice the problem immediately and risks some injury.

Third, any chemicals in the glue require extensive tests and approval processes to demonstrate that they are biocompatible, do not create some gas that deteriorates the receiver if the custom shell is assembled by the HCP.

Therefore, there is a need for providing a solution that allows for efficient prevention of contamination of hearing devices, while being safer for the user and enabling for an economically beneficial assembly process.

### BRIEF DESCRIPTION OF THE DRAWINGS

Below, embodiments are described in more detail with reference to the attached drawings.

FIG. 1 shows a first assembly step to build a first embodiment of an in-ear device schematically;

FIG. 2 shows a second assembly step to build the first embodiment of an in-ear device in a longitudinal section;

FIG. 3 shows a third assembly step to build the first embodiment of an in-ear device in a longitudinal section;

FIG. 4 shows a fourth assembly step to build the first embodiment of an in-ear device in a longitudinal section;

FIG. 5 shows a fifth assembly step to build the first embodiment of an in-ear device in a longitudinal section;

FIG. 6 shows the final assembly of the first embodiment of an in-ear device in a longitudinal section;

FIG. 7 shows a second embodiment of a connector in its original, uncut state in a longitudinal section;

FIG. 8 shows a third embodiment of a connector in its original, uncut state in a longitudinal section; and

FIG. 9 shows a fourth embodiment of a connector in its original, uncut state in a longitudinal section.

### DETAILED DESCRIPTION

The present embodiments concern the protection of a receiver of a hearing device, particularly an in-ear device, against undesired ingress of cerumen and promotes different assembly solutions.

The embodiments described herein overcome at least certain disadvantages in that they promote an in-ear device that is at least partially insertable into an ear canal of a user and that comprises a housing which that is mechanically releasably coupled to a connector. Said connector is made of an elastic material, has a tubular overall shape defining a longitudinal axis and radially delimits a sound channel. The tubular overall shape can have different longitudinal sections having different outer and inner diameters. The connector is mechanically releasably coupled to a loudspeaker unit at a second end of the connector. A cerumen protection unit is connected/attached to the connector by an adhesive-free and non-losable connection. As may be explained later, the connection can comprise a multi-body solution as well as a single-body solution where the cerumen protection unit is at least partially integrated into the connector.

There are several options available to derive that captivity of the cerumen filter unit without using any adhesive. Since the gluing process is not required any longer, the assembly process of the in-ear device is not only faster but also cleaner and allows for an automated assembly process, where needed.

The term “housing” is used hereinafter as a blanket term for custom shells of ITEs as well as for housings of earbuds alike.

The term “elastic material” addresses a flexibility of the connector in terms of ductility/elasticity that allows for a radial stretchability with respect to the longitudinal axis. An inner diameter of the connector is designed such that it can be radially stretched and widened such that the second end of the connector is movable in an axial direction over a coupling geometry arranged on a shell surface of the loudspeaker unit, for example a spout, such that the connector eventually holds the loudspeaker unit tightly by force-fit and/or form-fit.

The term “loudspeaker unit” is a blanket term that comprises both sound releasing components of an earbud as well as receivers of an ITE.

There are several synthetic materials available for the connector. Silicone rubber is sometimes chosen since it allows for a fast and inexpensive manufacturing process that allows for precise geometric details and features of the connector. The ductility degree/hardness of the connector is such than a fitter, for example the HCP, can shorten an excess length of the connector by a regular pair of scissors or a side cutter at a first end located at the opposite end to the second end once the connector is coupled to the housing.

The mechanical coupling of the connector to the loudspeaker is releasable to allow for an exchange of either the housing or the loudspeaker unit without a may dispose the entire in-ear device.

Note that the term “adhesive-free” connection hereinafter relates exclusively to the connection between the cerumen filter unit and the connector. It does not exclude that a filter element or other parts contain an adhesive for whatever reason.

A basic, yet exceptionally reliable releasable coupling between the housing and the connector is formed by a circumferentially extending coupling groove provided on a shell surface of the connector. Said coupling groove is configured such that it engages with a complementary shaped contour of a dedicated opening in the housing in a snug, form-fit manner.

When seen transversally to the longitudinal axis, a cross-section of the coupling groove may be U-shaped and such that sharp edges are avoided. When seen in the direction of the longitudinal axis, the dedicated opening in the housing has a cylindric cross-section. That allows using an economically beneficial rotation-symmetric connector geometry at least proximate to the coupling area.

The tear-out strength of the connector in the housing can be tailored to the needs required by designing the height of the flanks of the U-shaped cross-section of the coupling groove extending in the radial direction relative to the longitudinal axis accordingly. A certain tear-out strength is required to prevent an unintended decoupling of the housing and the connector in the direction of the longitudinal axis. The higher the flanks in the radial direction with respect to the longitudinal axis, the higher the tear-out strength of the connector relative to the housing, the higher the tear-out resistance. It is recommended to choose the radial height of the flanks such that there is a fair balance between a good insertion and mounting process of the connector to the housing at its dedicated opening and the tear-out strength. If needed, the radial flanks of the U-shaped coupling groove may have a different dimension. That may be beneficial if one wants the fitter to insert the connector in only one predefined way into the housing.

The flanks of the coupling groove function as a mayer element on the connector. The mayer element does not may extend about the full circumference of the shell surface of the connector. At least one knob-like protrusion extending in the radial direction may suffice if the rotation symmetry of the connector is no criteria to be met.

A size of the dedicated opening in the housing is dimensioned with respect to a radially extending flank height of the coupling groove at the lateral, second end of the coupling area of the connector such that the connector is prevented from being unintendedly pulled out and decoupled from the housing in the medial direction relative to the housing. In such an embodiment, the radially extending flank height of the coupling groove forms a natural abutment element. In an most basic embodiment of the connector, the connector has walls that are so soft and flexible such that they can be squeezed through the dedicated opening along the entire length of the first end of the connector at the insertion step and such that there is no need for an additional flange portion on the shell surface of the wall of the connector.

A second tear-out protection is available if the connector comprises an abutment element on its shell surface, which abutment element is located adjacent to the dedicated opening and on an outer wall side of the housing at a first end of the connector facing the eardrum in an assembled state of the in-ear device and when inserted into the ear canal of the user. That abutment element protrudes radially away from the longitudinal axis such that the connector is prevented from being unintendedly decoupled from the housing in the direction of the longitudinal axis towards the loudspeaker unit.

The abutment element may be dimensioned such that it is radially squeezable through the dedicated opening in the housing easily during the assembly process. The design variables reside in the dimensions of the mayer element and the ductility of the connector material in that coupling area.

A particularly simple geometry of the connector is achievable if the abutment element is a first flange that is circumferentially extending about the shell surface. However, just a partial circumferential extension would suffice to achieve the required functionality. If the first flange is not extending about the full circumference, it may be configured to serve as an anti-rotation lock (torsional lock) of the connector relative to the housing.

Additionally or as an alternative, a diameter of the loudspeaker unit at its spout coupled to the connector in the coupling area of the latter is selected such that once it widened the diameter of the connector on the second side of the connector located in the interior of the housing after its insertion process during the assembly of the in-ear device that the diameter of the connector gets bigger than the diameter of the dedicated opening, forms a second flange and thus increases the tear-out resistance.

It is possible to integrate the cerumen filter unit into the connector. In one embodiment, the cerumen filter unit comprises at least one circumferentially extending protrusion of the connector that is radially extending into the sound channel towards the longitudinal axis. The cerumen protection element can be a ring-like geometry that is located in the sound canal proximate to the portion that is configured to receive the loudspeaker unit. That cerumen protection element is formed in one-piece together with the tubular connector.

In one embodiment, that ring-like geometry extends about the full circumference relative to the longitudinal axis. Such an embodiment would narrow the diameter of the sound canal which may be disadvantageous in some applications. Another solution resides in that the ring-like geometry does not extend about the full circumference relative to the longitudinal axis but has a plurality of ring-shaped segments that are displaced from one another in the circumferential direction by a gap such that the free cross-section of the sound canal can be enlarged and optimized. In an exemplary embodiment, good test results were available if the ring-shaped segments obstructed less than 75%, e.g., less than 50% of the cross-section of the free sound channel, i.e., the diameter of the sound channel longitudinally proximate to the ring-shaped segments.

If there are several cerumen protection elements pointing towards the longitudinal axis, it may look like jagged teeth pointing radially inside from the connector wall into the sound channel when seen in the direction of the longitudinal axis. In yet another embodiment, the cerumen protection element may have the cross-section of a disc where a shamrock-like contour (three- or four-leaf clover contour) is removed to form the free sound channel cross section. As one can see, multiple design variations for the shape of the cerumen protection element or elements are conceivable.

If there is a feature to increase the efficiency of the at least one circumferentially extending protrusion against an undesired ingress of particles and pollutants into the loudspeaker unit, there are embodiments where the cerumen protection unit comprises a further cerumen protection element that is formed by at least one groove that is circumferentially extending on an inner wall of the tubular connector.

An even more complex further cerumen protection element can comprise a combination of grooves and ridges and/or a further radially inwardly protruding element, all arranged on an inner side of the wall of the tubular connector. A cerumen protection comprising both a protruding cerumen filter element and a groove that is circumferentially extending on an inner wall of the tubular connector would be particularly suitable to hold back liquid type cerumen.

The providing of such additional cerumen protection elements like additional grooves, ridges, baffle plates and the like are not restricted to the above embodiment and can be combined with any embodiments.

In yet another embodiment, the cerumen protection unit comprises at least one of a sound-permeable membrane and a mesh that are fully integrated into the connector. That types of cerumen protection elements are also formed in one-piece together with the tubular connector. The degree of the free cross section of the mesh may be chosen such that it can meet the features to a cerumen protection on the one hand and to keep the sound channel as open, i.e., unimpeded by mesh structure as possible. In a further embodiment, the cerumen protection element is formed by a membrane instead of a mesh. The membrane has a continuous surface that is sealing the connector portion towards the loudspeaker unit completely off against the ear canal. It is possible to produce a connector having a disc-shaped membrane extending radially to the longitudinal axis from wall to wall that is produced in one shot, measuring only a few micrometers thickness today, for example about 20 micrometers, such that sound emitted from the loudspeaker unit penetrates the membrane. In some examples, the membrane is provided as close to the loudspeaker as possible to keep the sound channel volume there as small as possible.

Now let us revert to embodiments where the cerumen protection unit is a structurally independent body from the connector. Such an embodiment is beneficial since it allows exchanging dirty/used filter elements against new/fresh/clean filter elements without a need of replacing the entire connector and dismantling the in-ear device.

In a basic embodiment of such an in-ear device, the cerumen protection unit comprises a filter element and a filter bushing that is configured to receive the filter element. The filter bushing has a hat-shaped cross-section when seen along the longitudinal axis. The filter bushing has a coupling portion that is configured to position and hold the actual filter element relative to the connector in place. The filter bushing has a collar portion that is configured to engage with a coupling area of the connector located on an inner wall of the connector on its radially peripheral end.

An outer diameter of the collar portion of the filter bushing is bigger than an original, i.e., an undeformed inner diameter of the connector at a coupling area of the connector located on an inner wall of the connector. The filter bushing is squeezed such into the sound channel of the connector that the inner diameter of the sound channel is widened during the process of pressing in the filter bushing into the first end of the connector until it reaches its designated position.

A frustoconical shape of the exterior shell surface of the filter bushing with a diameter rising from the lateral end towards the collar portion assist the insertion of the frustoconical portion of the filter bushing into the sound channel of the connector until a flank of the collar portion of the filter bushing abuts the end face of the connector stub. Thus, the collar portion forms an abutment/stop during the insertion of the filter bushing into the first end of the connector. The connector stub is created after fastening the connector to the housing and cutting an excessive portion of the tubular area at the first end of the connector that is protruding out of the housing off such that an end face of the connector remains. From that assembly stage on, the filter bushing is pressed in the longitudinal direction towards the second end of the connector until a rim of the collar portion snaps into the dedicated receiving positioning groove in the connector. In that position, the filter bushing is safely held and properly arranged in the connector. Superior results are available if a taper angle of the conical shape of the shell surface of the filter bushing is in a range between 5 and 10 degrees relative to the longitudinal axis.

As to the geometry of the filter bushing, it is advantageously rotation symmetric with respect to the longitudinal axis and has a hat-shaped cross section. Although a polygonal cross section of the filter bushing is conceivable, a rotation symmetric cross section may be used as it does not require a specific mounting orientation during the assembly process of the in-ear device.

The material of the filter bushing can be plastic, for example a hard thermoplastic or a metal.

The ductility and the wall dimensions of the connector are chosen such that the original diameter of the sound channel of the connector which was widened to the dimension of the outer diameter of the collar portion of the filter bushing into the coupling area of the connector shrinks back towards its original diameter once the collar portion passed it in the longitudinal direction during the insertion process. As a result, the filter bushing is positioned and held tightly within the connector and cannot get loose and fall off the in-ear device without the use of any adhesive. In other words, the collar portion of the filter bushing is held by way of force-fit of the ductile connector wall in the connector in such a solution.

It is advisable to select the dimension of the diameter of the sound channel in the connector at the coupling area and the ductility/elasticity of the connector such that one can still replace worn filter elements through the short stub easily. In case that the filter element itself has a flange that abuts the collar portion of the filter bushing when put in its dedicated place, then it is the diameter of that flange that may be smaller than the sound channel in the stub after it shrunk towards its original diameter.

It is possible to support and boost the second tear-out protection that prevents an accidental pulling out of the connector from the housing in the lateral direction, i.e., away from the ear in an operating state of the in-ear device. That is achievable if the outer diameter of the collar portion of the filter bushing is chosen to be about the same as, but in some cases being bigger than the diameter of the dedicated opening in the housing. Once the filter bushing is brought into its designated position in the coupling area of the connector, the wall of the connector proximate to the rim of the collar portion bulges radially outwards and contributes to employ the shear resistance of the connector between the collar portion of the filter bushing and the dedicated opening in the housing as an additional tear-out protection.

The tear-out resistance of the connector in the lateral direction relative to the housing can be further increased if the cross-section of the collar portion of the filter bushing is frustoconical with its radial diameter increasing from the medial to the lateral end. Rounded edges remain required to prevent an undesired notching effect in the coupling area of the connector. If such a geometry of the collar portion is intended, then it is recommended to shape and size the cross section of the positioning groove in the coupling area accordingly to ensure a snug fit of the collar portion of the filter bushing.

If the final assembly position of the filter bushing relative to the connector and the housing of the in-ear device may be precise and/or if the mechanical stress in the wall of the coupling area of the connector shall be kept within comparatively narrow boundaries, then it is advisable to provide a circumferentially extending positioning groove provided on the inside surface wall of the connector delimiting the sound channel. That positioning groove is configured to receive, engage with, and hold the collar portion of the filter bushing such that a positive lock mechanism is formed. To keep mechanical stress levels and the notching effect in the connector wall low but the durability high, it is beneficial if the positioning groove has a U-shaped cross section that extends in the circumferential direction about the longitudinal axis. That positioning groove is dimensioned and shaped to match the dimension and the shape of the corresponding collar portion of the filter bushing once the filter bushing is squeezed into the sound channel of the connector in the direction of the longitudinal axis such that the filter bushing is still held tightly within the connector and cannot get loose and fall off the in-ear device.

Please note that the above paragraph addresses the retainment of the filter bushing in the connector and not the retainment of the filter element in the filter bushing. The latter is discussed in the paragraph below.

The filter bushing has a coupling portion to engage with the filter element. Said coupling portion has a conical shape surface extending in the direction of the longitudinal axis with its smaller diameter pointing towards the second end of the connector. If the conical shape alone is not designed to secure the filter element in place by force-fit, then it is recommended to secure the filter element in the filter bushing by a form-fit, that is a positive lock mechanism. A favored design due to its simplicity and efficiency as well as replaceability of the filter element is available if the coupling portion of the filter bushing comprises a circumferential extending first form element provided on an inside of the conical shape surface. That first form element is configured to engage into an at least partially complementary shaped second form element provided on a shell surface of the filter element. Tests revealed that a circle segment is an ideal geometry to realize that first and second form elements. In some examples, the first form element extends about the full circumference of the filter element, although just a partly circumferential extension would suffice functionally. The form elements ensure further safety against unintentional decoupling in those cases where the taper angle is such that there is no force-fit between the bushing and the cerumen filter element. The taper degree of the conical shape surface is chosen such that it facilitates the insertion of a new filter element into the filter bushing.

The connector stub that remains after cutting the excessive portion of the tubular area at the first end of the connector can vary in length depending on where the fitter has cut the excessive portion off. There may be applications, where an intensification of the cerumen protection effect is desired without complicating the geometry of the connector.

The length of that stub can deliberately be chosen such that it serves as an additional cerumen protection element. In this case, the protecting effect originates of the remaining length at the first end of the connector offers extra connector surface where the cerumen can adhere and deposit to.

That additional cerumen protection element can complement embodiments of the in-ear device where the cerumen protection unit is fully or partly integrated into the connector as well as embodiments where the cerumen protection unit is a structurally separate unit to the connector.

These and other aspects may be apparent from and elucidated with reference to the embodiments described hereinafter.

The reference characters used in the drawings are explained hereinafter, where required. Identical and functionally identic items are given the same or similar reference characters in the figures.

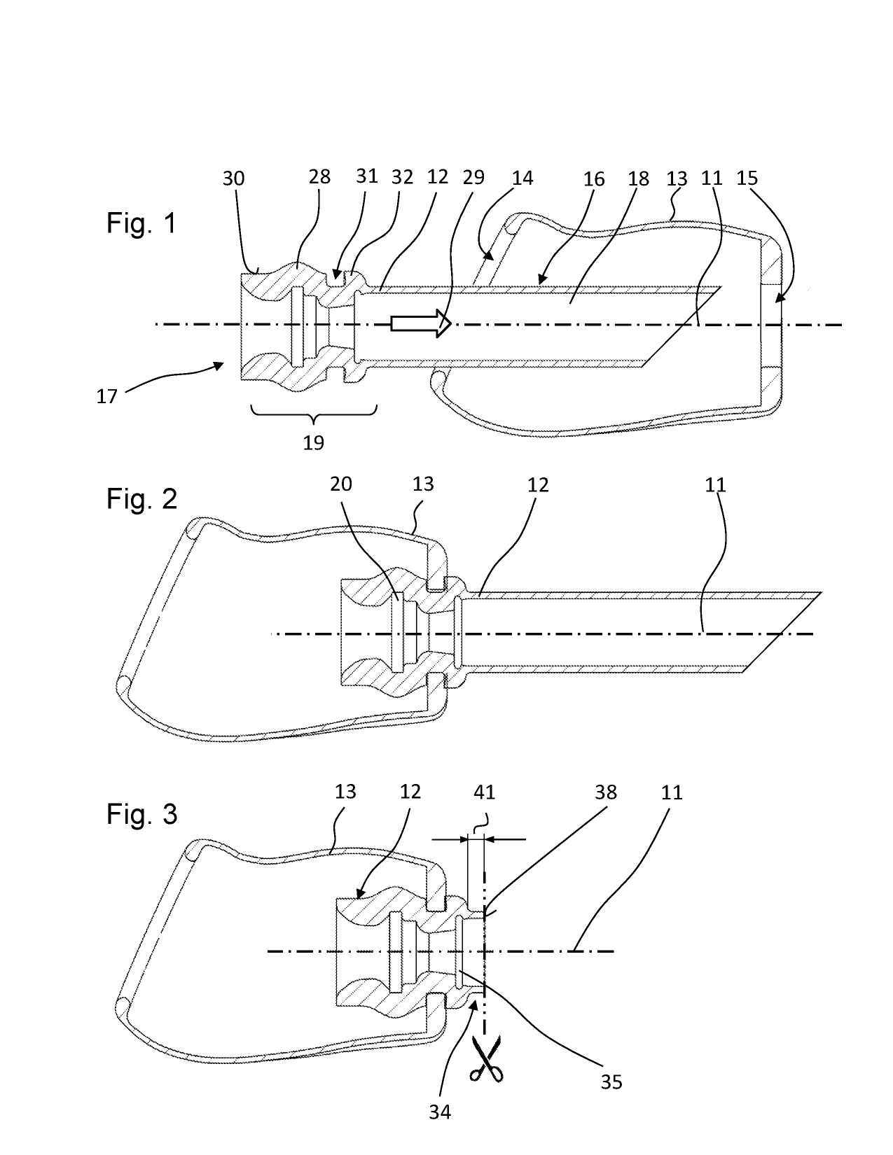

FIG. 1 to FIG. 5 show a mounting sequence to arrive eventually at an assembled in-ear device 10 such as shown in FIG. 6.

FIG. 1 shows across-section along a longitudinal axis 11 defined by the overall tubular shape of a silicone connector 12 through said silicone connector 12 and through a housing 13 of a custom shell of an ITE. The housing 13 is formed by additive manufacturing titanium material. The shell contour of the housing 13 is formed to match an interior shape and size of a user’s ear canal (not shown) in which the in-ear device 10 may be worn.

The housing 13 has an orifice 14 at its lateral end that is configured to receive an interface (not shown) of the ITE. The electronic and other components of the ITE are connected to that interface. At the medial end of the housing 13, a standardized dedicated opening 15 is provided. Said dedicated opening 15 has a cylindric cross section when seen in the direction of the longitudinal axis 11 and has smoothened edges to prevent any damage to the soft silicone connector 12 in the assembled state.

The connector 12 has a first medial end 16 and second lateral end 17. A sound channel 18 extends through the connector 12. The first end 16 comprises a coupling area 19 that is configured to receive a cerumen protection unit 25 (see FIG. 6) and a spout 26 of a loudspeaker 27 (here formed by a receiver) such as shown in FIG. 5. Note that the geometry shown in FIG. 1 is just a schematic one and may look a little different in reality because the coupling area shown in FIG. 1 shows the contour of the connector 12 in the assembled state of the ITE 10 where a wall 28 of the connector 12 is radially deformed and widened by the presence of the spout 26 of a loudspeaker unit 27 and the cerumen protection unit 25. Thus, the real inner and outer contour line of the sound channel of coupling area 19 of connector 12 may have a diameter and shape that is more like the diameter of the sound channel 18 at the medial end 16 of the connector 12 in FIGS. 1 to 4.

In FIG. 1, the medial first end 16 of the connector 12 is still comparatively long and cut in a slant to facilitate the insertion of the connector 12 in the orifice 14 and the dedicated opening 15. Opposing the first end 16, the second end 17 with the coupling area 19 of the connector 12 is moved in the direction of the first arrow 29 towards the dedicated opening 15.

On its shell surface 30, the connector 12 comprises a coupling groove 31. The coupling groove 31 has a U-shaped cross section with smooth corners to avoid mechanical stress and a long life of the connector 12 once it engages with the dedicated opening 15. On the medial side of the coupling groove 31 a first flange 32 is provided on top of the shell surface 30. On the interior side of the connector 12 laterally of the coupling groove 31, a coupling contour for receiving the spout 26 of the receiver 27 is provided. In the embodiment shown in FIGS. 1 to 6, said coupling contour comprises an inner groove 20 that is configured to engage in a form-fit as well as in a force-fit manner with the elastic silicon connector 12. However, the coupling contour for receiving the receiver 27 may have any suitable configuration can be designed different to the one shown in FIGS. 1 to 6 as long as the mechanical coupling is releasable.

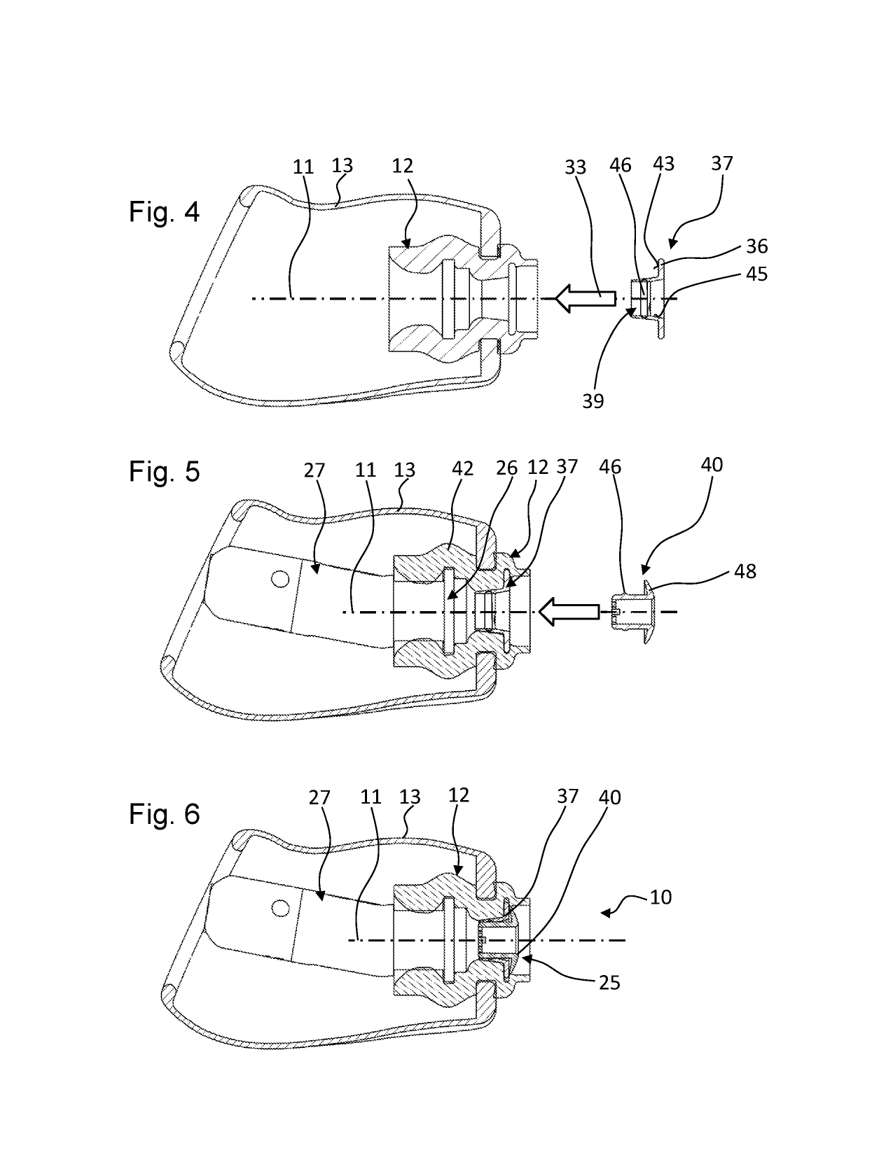

When reverting to FIG. 2, one can see that the connector 12 was further inserted into the dedicated opening 15 such that the coupling groove 31 fully engaged with the wall portion of the housing 13 proximate to the dedicated opening 15. To arrive at the situation shown in FIG. 2, one grabs the medial end 16 of the connector 12 once it protrudes/extends out of the dedicated opening 15 and pulls it in the direction of a first arrow 29 until the first flange 32 hits the inner wall of the housing 13 proximate to the dedicated opening 15. Next, one keeps on pulling the medial end 16 of the connector 12 such that the soft first flange 32 deforms and passes through the dedicated opening 15. Once the first flange 32 passed through the dedicated opening 15, it pops back to its original shape and size (as shown in FIG. 1) and the coupling groove 31 snaps into its designated position at the wall of the housing 13 at the dedicated opening 15 such that the connector 12 is tightly fastened to the housing 13. However, the connection is a releasable one and one can grab the second end 17 of the connector 12 and pull the connector 12 in a direction of a second arrow 33 as shown in FIG. 4 out of the housing 13 again.

To prevent an accidental tear-out of the connector 12 out of the housing 13 in the direction of the first arrow 29, a radially extending flank height of the coupling groove 31 at a second end 17 is dimensioned accordingly.

The difference of the assembly state shown in FIG. 3 to the assembly state shown in FIG. 2 resides in that the excessive portion of the first end 16 of the connector 12 is cut off such that there remains only a comparatively short stub 34 left at the first end 16 of the connector 12 that is protruding out of the dedicated opening 15 in the medial direction in an assembled state. The stub 34 has an axial end face 38 that serves as a natural abutment for the collar portion of the filter bushing prior to its insertion process into the connector 12. A length 41 of that stub is chosen such that it leaves some extra surface that serves as docking surface for cerumen.

The connector shown in FIG. 3 also shows that a circumferentially extending positioning groove 35 is provided on an inside wall sur-face of the connector 12 that delimits the sound channel 18. The positioning groove 35 is configured to receive, engage with and hold a collar portion of a filter bushing such that a positive lock mechanism is formed. The positioning groove 35 has a U-shaped cross section with smooth corners to avoid mechanical stress and a long life of the connector 12 once it engages with the collar portion 36 of a filter bushing 37.

An outer diameter of the collar portion 36 is about the same as the diameter of the dedicated opening 15 in the housing 13. The size of the positioning groove 35 is chosen such that it holds and positions the filter bushing 37 securely within the connector 12 in an assembled state. A peripheral rim at the outer diameter of the collar portion 36 has a smooth and semi-circular cross-section that facilitates the insertion of the filter bushing 37 into the first end 16 of the connector 12 at the stub 34.

As shown in FIG. 4 also in a longitudinal cross-section, the polymeric filter bushing 37 has a hat-shaped cross-section with a radially extending collar portion 36. The polymeric filter bushing 37 is mechanically harder than the silicon connector 12 such that one can squeeze the filter bushing into the stub 34 of the connector 12 in the direction of the second arrow 33 without doing detrimental damage to the collar portion 36 of the filter bushing 37.

The exterior shell surface of the rotation symmetric filter bushing 37 is conical with a diameter rising from its lateral end towards the collar portion 36 with an angle of about 10-15 degrees relative to the longitudinal axis. That angle assists and facilitates the insertion of the frustoconical portion of the filter bushing 37 until a flank 43 of the collar portion 36 abuts the end face 38 of the connector stub 34 before one starts pressing in the filter bushing 37 into the connector 12 from the first end 16.

FIG. 4 further shows that the filter bushing 37 has a coupling portion 39 to engage with a replaceable filter element 40. Said coupling portion 39 has a conical shape surface 45 extending in the direction of the longitudinal axis 11 with its smaller diameter pointing towards the second end 17 of the connector 12. The coupling portion 39 has a first form element 46 having a wedge-like or segment of a circle shaped cross section that protrudes in a ridge-like manner from the conical shape surface 45 away from the longitudinal axis 11.

As shown in FIG. 5, the filter element 40 has a complementary second form element 47 that is formed by a circumferentially extending ridge with a cross-section that complements the first form element 46 such that the filter element 40 is held and positioned securely in the filter bushing 37 in an assembled state (see FIG. 6). The filter element 40 is held by that form-fit of the first form element 46 and the second form element 47 in the filter bushing 37, not by force-fit via the tapered surface of the conical shape surface 45 until one grabs and pulls out the filter element 40 in the direction of the first arrow 29 with a special tool, for example a tool similar to a corkscrew driver.

The interior of the filter element 40 is schematically shown in the figures. In the present case, the filter element shown has just some orifices in the bottom of its lateral part that allow sound waves to pass but blocks cerumen and particles from entering the sound channel before the loudspeaker unit 27. The filter element 40 is typically made of a polymer. On its medial end, the filter element 37 has a flange 48 that abuts the collar portion 36 of the filter bushing 37 when put in place. That flange 48 helps to visually recognize the proper position of the filter element 40 in the filter bushing 37 during the insertion process in that one can press in the filter element 40 in the direction of the second arrow 33 until its flange 48 hits the collar portion 36 of the filter bushing 37. This is the position when the first form element 46 engages with the second form element 47 and forms a releasable positive lock between the filter element 40 and the filter bushing 37 such as shown in FIG. 6.

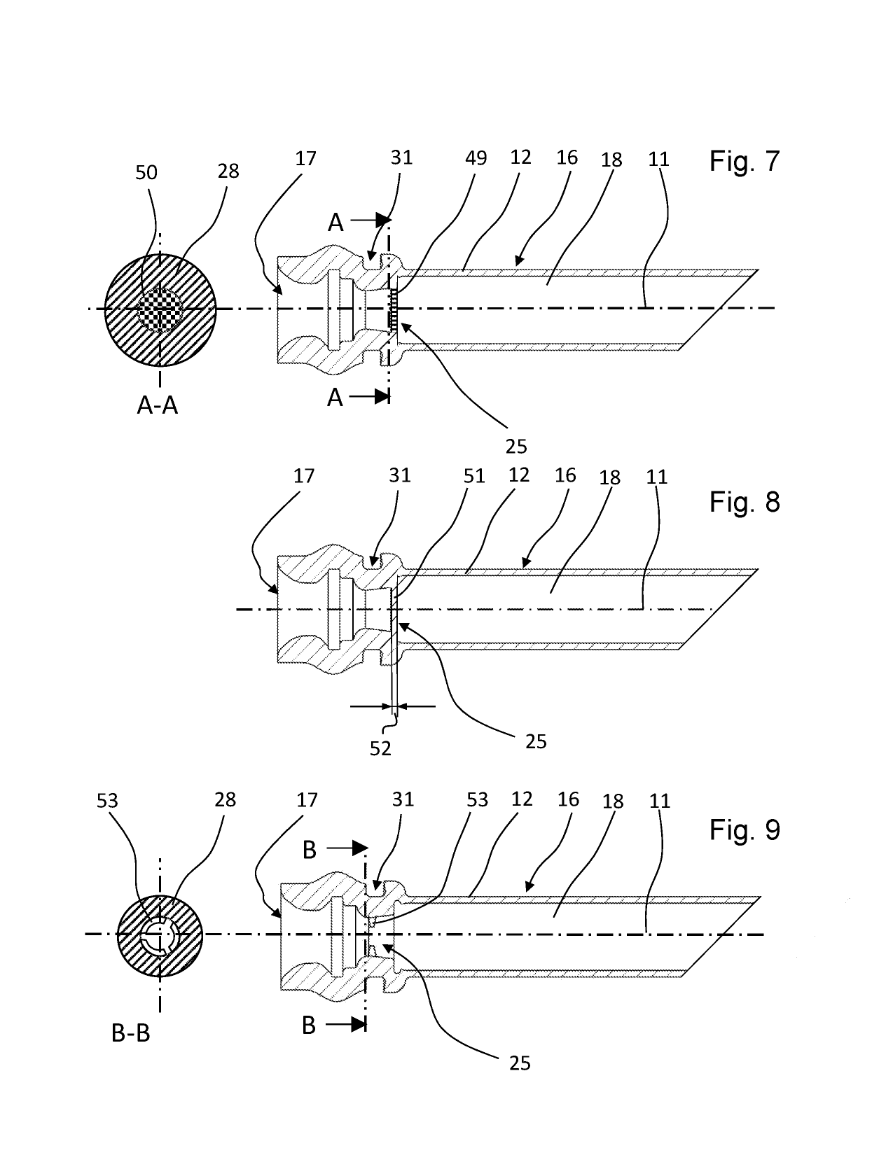

The dimension of the diameter of the sound channel 18 in the connector 12 at the coupling area 19 and the ductility/elasticity of the connector 12 are selected such that one can still replace worn filter elements 40 through the stub 34 easily despite that the diameter of the connector 18 has shrunken towards its original diameter after the collar portion 36 of the filter bushing 36 passed by in the direction of the longitudinal axis 11 during the insertion process of the filter bushing 37. At the second end 17 of the connector 12, a circumferentially extending second flange 42 is formed in that the spout 26 of the loudspeaker unit 27 is bulging and widening an outer diameter of the connector 12 in the coupling area 19 such that becomes bigger than the diameter of the dedicated opening 15. That forms a further tear-out protection against an accidental pull-out of the connector 12 in the direction of the first arrow 29 relative to the housing 13. Although it looks like there is a second flange 42 shown in FIGS. 1 to 4, please mind that these figures merely illustrate schematic, not picturing assembly steps where the second flange 42 would not be that dominant in these figures in reality since the spout 26 of the loudspeaker unit 27 is not inserted into the second end 17 of the connector 12 such as shown in FIG. 5, yet. The same holds true for the embodiments of the connectors shown in FIGS. 7 to 9.

Although an assembly sequence of connecting the connector 12 to the housing 13 first, followed by inserting the cerumen protection unit 25 in case it is not already integrated into the connector 12, and followed by connecting the receiver/loudspeaker unit 27 to the connector 12, is shown in FIGS. 1 to 6, the mounting sequence can be different. For example, the loudspeaker unit 27 may be coupled to the connector 12 before the connector 12 is coupled to the housing 13. In case of a multi-part cerumen protection unit 25 with a filter bushing 37 and a filter element 40 it is possible to insert the filter bushing 37 without the filter element 40 into the coupling area 19 of the connector 12, or to insert the filter element 40 into the filter bushing 37 prior to the insertion into of the filter bushing 37 together with its pre-inserted filter element 40 into the coupling area 19 of the connector 12. More mounting sequence alternatives are available, if some geometric features and dimensions of the in-ear device are altered.

Contrary to the embodiment of the connector shown in FIGS. 1 to 6, the embodiments of the connectors shown in FIGS. 7 to 9 comprise a cerumen protection unit that is structurally fully integrated into the connector, each. As a result, the cerumen protection unit is positioned and secured safely within the connector and cannot get loose and fall off intrinsically.

The connector 12 shown in FIG. 7 is shown in its full length and in the state prior to cutting off its excessive length at the first end after insertion into the housing 13 similar to the connector shown in FIGS. 1 and 2. The section view A-A of FIG. 7 shows an embodiment where the cerumen protection unit 25 is formed by a mesh 49 that is provided inside the coupling area 19 of connector 12. The mesh has a thickness extending in the direction of the longitudinal axis 11 of about 20 micrometers. The openings 50 in the mesh have a size of 0.05mm to 0.5mm to allow a direct, i.e. an uninterrupted sound path for the sound emitted from the loudspeaker unit through the mesh 49 to the eardrum in an operating state of the in-ear device. The size of the openings depends on the features on the cerumen filtering. The mesh 49 is formed in the same injection molding shot as the rest of the connector 12 and comprises a silicon material, again.

The connector 12 shown in FIG. 8 is shown in its full length and in the state where the first medial end 16 excessing a short stub 34 such as shown in the context of the first embodiment shown in FIGS. 1 and 2, too. Instead of a mesh, the embodiment of FIG. 8 has a cerumen protection unit 25 in the form of a planar, full-surface sound-permeable membrane 51 that is sealing off the sound channel in the sound channel 18 at the second lateral end 17 of the connector 12, once the loudspeaker unit (receiver) is connected to the connector (not shown). The membrane 51 has a thickness 52 extending in the direction of the longitudinal axis 11 of about 20 micrometers. The membrane 51 is formed in the same injection molding shot as the rest of the connector 12 and comprises a silicon material, again. This embodiment not only ensures an optimal ingress protection against cerumen or other particles that enter the sound canal from the medial first end 16 when in use but guarantee that the cerumen protection unit is positioned and secured safely within the connector and cannot get loose and fall off. For the sake of completeness, it is herewith mentioned that the medial first end 16 of the connector 12 excessing a stub 34 may be cut-off such as shown in FIG. 3.

The cerumen protection unit 25 of the further embodiment of a connector 12 shown in FIG. 9 is also integrated into the connector 12 such as the mesh shown in the embodiment of FIG. 7 and allowing a direct, i.e. an uninterrupted sound channel for the sound emitted from the loudspeaker unit to the eardrum in an operating state of the in-ear device. Different to the connector shown in FIG. 7, the cerumen protection unit 25 shown in FIG. 9, especially the section view B-B reveal a geometry in form of three ring-shaped segments 53 that are protruding from the wall of the connector 12 radially inwards towards the longitudinal axis 11 and therefore form an obstacle for cerumen or other particles that enter the sound canal 18 from the medial first end 16 in an operating state of the in-ear device. The three ring-shaped segments 53 are formed in the same injection molding shot as the rest of the connector 12 and comprises a silicon material, again. For the sake of completeness, it is herewith mentioned that the medial first end 17 of the connector 12 excessing a stub 34 may be cut-off such as shown in FIG. 3.

It is possible to combine the connector with the mesh and the three ring-shaped segments, for example if there is a may protect the membrane.

### LIST OF REFERENCE SYMBOLS

10 in-ear device 10

11 longitudinal axis

12 connector

13 housing

14 orifice at the lateral end of the housing

15 dedicated opening

16 first, medial end of the connector

17 second, lateral end of the connector

18 sound channel

19 coupling area of the connector

20 inner groove

25 cerumen protection unit

26 spout of a loudspeaker unit

27 loudspeaker unit (receiver)

28 wall of the connector

29 first arrow

30 shell surface of the connector

31 coupling groove

32 abutment element / first flange

33 second arrow

34 short stub of the connector

35 positioning groove

36 collar portion of the filter bushing

37 filter bushing

38 end face of the connector stub

39 coupling portion of the filter bushing

40 filter element

41 remaining length the short stub in the direction of the longitudinal axis

42 second flange

43 flank of the collar portion

45 conical shape surface of the filter bushing

46 first form element

47 second form element

48 flange of the filter element

49 mesh

50 openings in the mesh

51 membrane

52 thickness of the membrane

53 protrusion(s) / ring-shaped segments

What is claimed is:

1. An in-ear device that is at least partially insertable into an ear canal of a user,
wherein the in-ear device comprises a housing, a loudspeaker unit and an elastic connector, wherein the elastic connector is releasably coupled to a dedicated opening provided in the housing by a circumferentially extending coupling groove provided on a shell surface of the connector that is configured such that it engages with a contour of the dedicated opening in the housing in a form-fit manner,
and wherein the connector has a tubular overall shape defining a longitudinal axis and radially delimits a sound channel, and wherein the connector is mechanically releasably coupled to the loudspeaker unit at a second end of the connector,
and wherein an inner diameter of the connector is designed such that it can be radially stretched and widened such that the second end of the connector is movable in an axial direction over a coupling geometry arranged on a shell surface of the loudspeaker unit such that the connector holds the loudspeaker unit tightly by force-fit and/or form-fit.

2. The in-ear device according to claim 1, wherein a cerumen protection unit is connected to the connector by an adhesive-free and non-losable connection.

3. The in-ear device according to claim 2, wherein the cerumen protection unit comprises a cerumen protection element that is formed by at least one circumferentially extending protrusion of the connector that is radially extending into the sound channel towards the longitudinal axis.

4. The in-ear device according to claim 3, wherein the at least one circumferentially extending protrusion comprises a plurality of ring-shaped segments.

5. The in-ear device according to claim 2, wherein the cerumen protection unit comprises a further cerumen protection element that is formed by at least one groove that is circumferentially extending on an inner side of a wall of the tubular connector.

6. The in-ear device according to claim 2, wherein the cerumen protection unit comprises at least one of a sound-permeable membrane and a mesh that is fully integrated into the connector.

7. The in-ear device according to claim 2, wherein the cerumen protection unit comprises a filter element and a filter bushing that is configured to receive the filter element, and wherein the filter bushing has a hat-shaped cross-section when seen in a cross-section along the longitudinal axis, and wherein the filter bushing has a coupling portion that is configured to position and hold the filter element relative to the connector in place and a collar portion that is configured to engage with a coupling area of the connector on an inner wall side of the connector delimiting the sound channel.

8. The in-ear device according to claim 7, wherein a ductility and wall dimensions of the connector are chosen such that an original diameter of the sound channel that was widened to an outer diameter of the collar portion of during an insertion process of the filter bushing into the coupling area of the connector shrinks back towards the original diameter once the collar portion passed it in the longitudinal direction during the insertion process.

9. The in-ear device according to claim 7, wherein an outer diameter of the collar portion of the filter bushing is bigger than or about the same as a diameter of the dedicated opening in the housing configured to receive the connector.

10. The in-ear device according to claim 7, wherein the connector has a circumferentially extending positioning groove provided on its inside surface, which positioning groove is configured to receive, engage with and hold the collar portion of the filter bushing such that a positive lock mechanism is formed, wherein a size of the positioning groove is chosen such that it holds and positions the filter bushing securely within the connector in an assembled state.

11. The in-ear device according to claim 7, wherein the coupling portion of the filter bushing has a conical shape surface extending in the direction of the longitudinal axis with its smaller diameter pointing towards the second end of the connector, and wherein the coupling portion of the filter bushing comprises a circumferentially extending first form element provided on an inside of the conical shape surface, which first form element is configured to engage into an at least partially complementary shaped second form element provided on a shell surface of the filter element such that a releasable positive lock between the filter element and the filter bushing is formed.

12. The in-ear device according to claim 7, wherein a remaining length of the connector protruding out of the housing in the direction of the longitudinal axis at a first end of the connector after a step of inserting the connector to the housing during an assembly process of the in-ear device is such that it forms an additional cerumen protection element in that it offers extra connector surface where the cerumen can adhere to.

13. The in-ear device according to claim 1, wherein a size of the dedicated opening in the housing is configured with respect to a radially extending flank height of the coupling groove at a second end of the connector such that the connector is prevented from being unintendedly pulled out and decoupled from the housing in a medial direction relative to the housing.

14. The in-ear device according to claim 1, wherein the connector comprises an abutment element on its shell surface, which abutment element is located adjacent to the dedicated opening and the coupling groove such that it touches an outer wall side of the housing at a first end of the connector in an coupled state of the connector and the housing, wherein the abutment element protrudes radially away from the longitudinal axis such that the connector is prevented from being unintendedly decoupled from the housing in the direction of the longitudinal axis towards the loudspeaker unit.

15. The in-ear device according to claim 14, wherein the abutment element is a first flange that is circumferentially extending about the shell surface of the connector.
